(19) United States
(12) Patent Application Publication
(10) Pub. No.: US 2021/0031474 A1
(43) Pub. Date: Feb. 4, 2021

(54) MOLDING APPARATUS FOR FORMING SHOE COMPONENT AND HAVING LOW ENERGY CONSUMPTION

(71) Applicant: POU CHEN CORPORATION, Chang Hwa Hsien (TW)

(72) Inventors: Nai-Chuan TSAI, Lukang Township (TW); Nai-Yung TSAI, Changhua County (TW)

(73) Assignee: POU CHEN CORPORATION, Chang Hwa Hsien (TW)

(21) Appl. No.: 16/691,056

(22) Filed: Nov. 21, 2019

(30) Foreign Application Priority Data
Aug. 2, 2019 (TW) 108127517

(51) Int. Cl. B29D 35/12; B33Y 80/00

(52) U.S. Cl. CPC B29D 35/128; B29D 35/122; B33Y 80/00

(57) ABSTRACT

A molding apparatus for forming a shoe component includes first and second molds. The first mold includes a first outer mold having an inner base surface and an inner peripheral surface that cooperatively define a first receiving space, and a first inner mold disposed in the first receiving space. The second mold includes a second outer mold having an inner base surface and an inner peripheral surface that cooperatively define a second receiving space, and a second inner mold disposed in the second receiving space. The first and second molds are movable toward and away from each other. The first and second inner molds cooperatively define a mold cavity.

### CROSS-REFERENCE TO RELATED APPLICATION

This application claims priority to Taiwanese Patent Application No. 108127517, filed on Aug. 2, 2019.

### FIELD

The disclosure relates to a forming mold, more particularly to a molding apparatus that is used for forming a shoe component, that has low energy consumption and that is used for hot compacting.

### BACKGROUND

An existing forming mold for a foam sole is mounted on a forming equipment. The forming mold includes two outer molds and two inner molds disposed fittingly and respectively in the outer molds. The inner molds cooperatively define a mold cavity when the outer molds are moved toward each other to a closed position. In use, a shoe component blank made of a foam material is placed in one of the inner molds, after which the forming equipment is operated to move the outer molds toward each other to the closed position. The outer molds are then heated to a working temperature, so that the shoe component blank will foam and expand to fill the mold cavity, thereby forming a shoe component, which is the foam sole.

Although the aforesaid forming mold has the characteristics of hot compacting, since the heating of the outer molds is conducted from outer surfaces thereof, most of the heat during heating is dissipated into the air, causing waste of energy. Since repeated heating and cooling operations are required during the forming process, and since the inner molds respectively abut against inner surfaces of the outer molds to conduct heating or cooling, the sizes of the two inner molds are large and cannot be reduced, so that the heating and cooling time are not only increased, but there is also waste of energy. Further, because the inner molds are indirectly heated, there will also be an issue of uniformly heating the inner molds.

### SUMMARY

Therefore, an object of the present disclosure is to provide a molding apparatus for forming a shoe component that is capable of alleviating at least one of the drawbacks of the prior art.

According to this disclosure, a molding apparatus for forming a shoe component includes a first mold and a second mold. The first mold includes a first outer mold having an inner base surface and an inner peripheral surface that cooperatively define a first receiving space, and a first inner mold disposed in the first receiving space and having a first heating structure. The first inner mold and the inner peripheral surface of the first outer mold have a first gap formed therebetween. The second mold includes a second outer mold having an inner base surface and an inner peripheral surface that cooperatively define a second receiving space, and a second inner mold disposed in the second receiving space and having a second heating structure. The second inner mold and the inner peripheral surface of the second outer mold have a second gap formed therebetween. The first and second molds are movable toward and away from each other. The first and second inner molds cooperatively define a mold cavity.

### BRIEF DESCRIPTION OF THE DRAWINGS

FIG. 1 is a schematic view of a forming equipment incorporating a molding apparatus according to the first embodiment of the present disclosure;

FIG. 2 is an assembled sectional view of the first embodiment;

FIG. 3 is an assembled sectional view of the first embodiment taken from another angle;

FIG. 4 is a plan view of the first mold of the first embodiment;

FIG. 5 is a plan view of the second mold of the first embodiment;

FIG. 6 is an assembled sectional view of the second embodiment;

FIG. 7 is an assembled sectional view of the second embodiment taken from another angle;

FIG. 8 is an assembled sectional view of the third embodiment;

FIG. 9 is an assembled sectional view of the third embodiment taken from another angle;

FIG. 10 is an assembled sectional view of the fourth embodiment;

FIG. 11 is an assembled sectional view of the fourth embodiment taken from another angle; and

FIG. 12 is an assembled sectional view of the fifth embodiment.

### DETAILED DESCRIPTION

Before the present disclosure is described in greater detail, it should be noted herein that like elements are denoted by the same reference numerals throughout the disclosure.

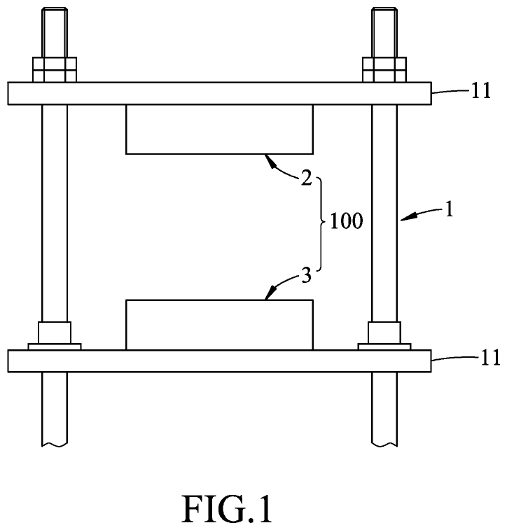

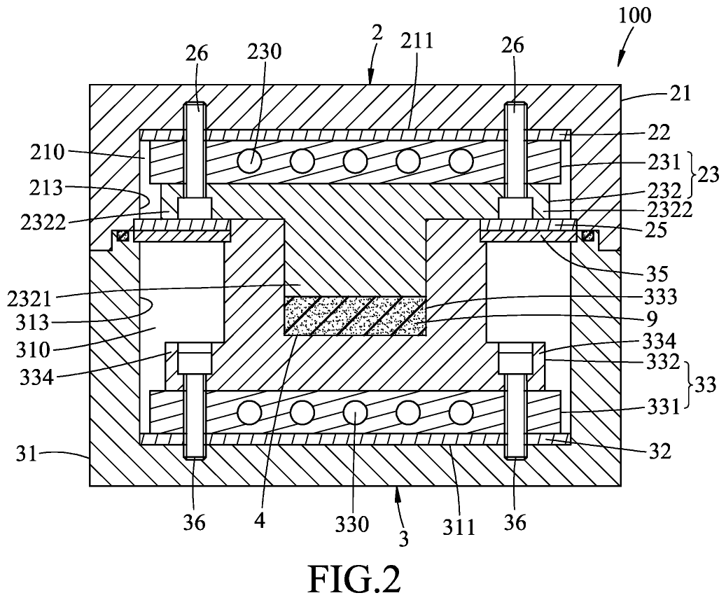

FIG. 1 illustrates a forming equipment 1 incorporating a molding apparatus 100 for forming a shoe component according to the first embodiment of the present disclosure. The forming equipment 1 includes two mounting plates 11 that are movable toward or away from each other along a mold closing direction (Z). The molding apparatus 100 of this embodiment is used for hot compacting a shoe component blank (not shown), which is made of a foam material, such as plastic or rubber, into a shoe component 9 (see FIG. 2). In this embodiment, the shoe component 9 is exemplified as a shoe sole. The molding apparatus 100 of this embodiment includes a first mold 2 and a second mold 3 respectively mounted on the mounting plates 11.

Referring to FIGS. 2 to 4, the first mold 2 includes a first outer mold 21, a first thermal insulation plate 22, a first inner mold 23, a first through pipe 24 and a first cover plate 25. The first outer mold 21 has an inner base surface 211 and an inner peripheral surface 213 cooperatively defining a first receiving space 210, and a first air hole 212 extending through the inner peripheral surface 213 to allow communication between the first receiving space 210 and an external environment. The first thermal insulation plate 22 and the first inner mold 23 are sequentially disposed in the first receiving space 210.

The first inner mold 23 has a first heating plate 231 disposed on the first thermal insulation plate 22, a first inner mold body 232 disposed on the first heating plate 231 opposite to the first thermal insulation plate 22, a protruding portion 2321 protruding out of the first receiving space 210 from the first inner mold body 232, and at least three first connecting portions 2322 formed on a peripheral edge of the first inner mold body 232 for connection with the first outer mold 21 using a plurality of screw bolts 26. Through this, the first inner mold body 232, the first heating plate 231 and the first thermal insulation plate 22 are fastened to the inner base surface 211 of the first outer mold 21.

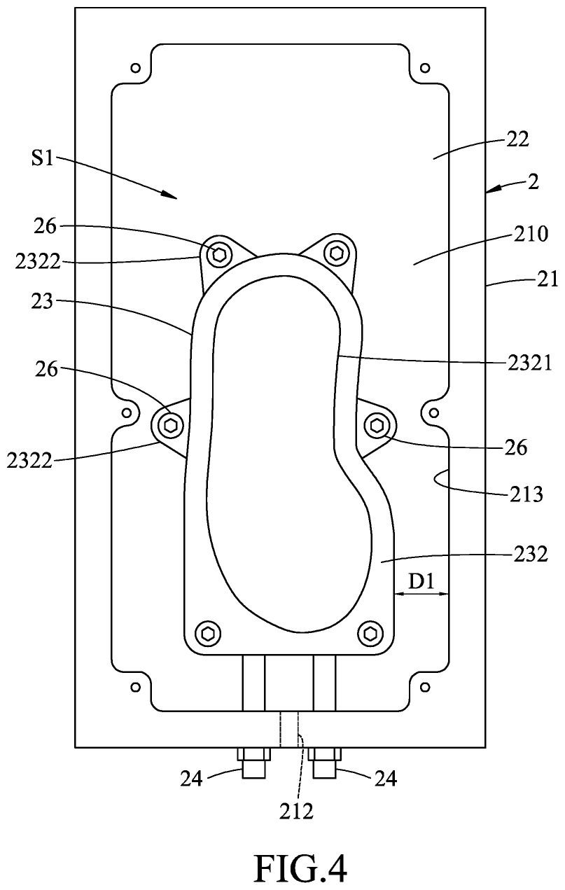

The first heating plate 231 is formed with at least one first flow channel 230 having one end extending through an outer surface thereof for connection of the first through pipe 24 therewith. In this embodiment, two first flow channels 230 are formed in the first heating plate 231 for connection of two first through pipes 24 respectively therewith (see FIG. 4). By using a supply device (not shown) that supplies hot fluid, such as hot steam or hot water, into the first flow channels 230 through the respective first through pipes 24, a first heating structure (H1) is formed, and a heating effect can be achieved. However, in actual practice, cold fluid, such as ice water, may be introduced into the first flow channels 230 to achieve a cooling effect. In this embodiment, for convenience of processing and assembly, the first through pipes 24 and the first air hole 212 are disposed on the same side.

A first gap (S1) is formed between the peripheral edge of the first inner mold body 232 and the inner peripheral surface 213 of the first outer mold 21. The peripheral edge of the first inner mold body 232 and the inner peripheral surface 213 of the first outer mold 21 have a shortest distance (D1) therebetween larger than or equal to 5 mm, preferably larger than or equal to 10 mm.

In this embodiment, the presence of the first gap (S1) in the first mold 2 can block the thermal energy of the first heating structure (H1), so that outward heat transmission can be reduced, and the effect of low energy consumption can be achieved. Simultaneously, the first inner mold 23 is removably connected to the first outer mold 21 by operating the screw bolts 26, so that the first inner mold 23 can be replaced with a different shoe component shape. Thus, the flexibility of this disclosure can be increased, and the manufacturing cost thereof can be reduced.

The first cover plate 25 matches the shape of the first inner mold 23 to cover and seal the first gap (S1), so that the outward heat transmission can be effectively blocked.

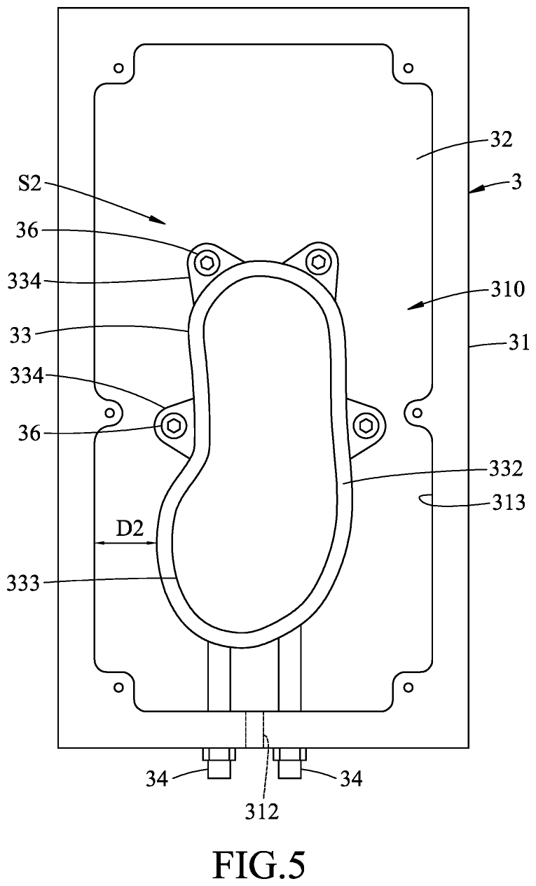

Referring to FIG. 5, in combination with FIGS. 1 to 3, the second mold 3 includes a second outer mold 31, a second thermal insulation plate 32, a second inner mold 33, a second through pipe 34, a second cover plate 35 and a temperature sensor 37. An O-ring is disposed between the first outer mold 21 and the second outer mold 31. The second outer mold 31 has an inner base surface 311 and an inner peripheral surface 313 cooperatively defining a second receiving space 310 which opens toward the first receiving space 210, and a second air hole 312 extending through the inner peripheral surface 313 to allow communication between the second receiving space 310 and the external environment.

The second thermal insulation plate 32 and the second inner mold 33 are sequentially disposed in the second receiving space 310. The second inner mold 33 and the first inner mold 23 are engaged to each other and cooperatively define a mold cavity 4 when the first and second molds 2, 3 are moved toward each other and abut against each other. The mold cavity 4 is used for forming the shoe component 9.

The second inner mold 33 has a second heating plate 331 disposed on the second thermal insulation plate 32, a second inner mold body 332 disposed on the second heating plate 331 opposite to the second thermal insulation plate 32, a concave portion 333 extending inwardly from the second inner mold body 332 for receiving and cooperating with the protruding portion 2321 to confine the mold cavity 4 therebetween, and at least three second connecting portions 334 formed on a peripheral edge of the second inner mold body 332 for connection of a plurality of screw bolts 36 therewith. Through this, the second inner mold body 332, the second heating plate 331 and the second thermal insulation plate 32 are fastened to the inner base surface 311 of the second outer mold 31.

The second heating plate 331 is formed with at least one second flow channel 330 having one end extending through an outer surface thereof for connection of the second through pipe 34 therewith. In this embodiment, two second flow channels 330 are formed in the second heating plate 331 for connection of two second through pipes 34 respectively therewith (see FIG. 5). By using the supply device (not shown) that supplies hot fluid, such as hot steam or hot water, into the second flow channels 330 through the respective second through pipes 34, a second heating structure (H2) is formed, and a heating effect can be achieved. However, in actual practice, cold fluid, such as ice water, may be introduced into the second flow channels 330 to achieve a cooling effect. In this embodiment, for convenience of processing and assembly, the second through pipes 34 and the second air hole 312 are disposed on the same side. Preferably, the second inner mold body 332 has a wall thickness ranging between 50 mm and 75 mm.

The first heating structure (H1) and the second heating structure (H2) are not limited to channel structures respectively formed in the first and second heating plates 231, 331. In other embodiments, the first and second heating structures (H1, H2) may be replaced by heaters, such as a resistive heater, a high frequency heater, etc.

A second gap (S2) is formed between the peripheral edge of the second inner mold body 332 and the inner peripheral surface 313 of the second outer mold 31. The peripheral edge of the second inner mold body 332 and the inner peripheral surface 313 of the second outer mold 31 have a shortest distance (D2) therebetween larger than or equal to 5 mm, preferably larger than or equal to 10 mm.

In this embodiment, the presence of the second gap (S2) in the second mold 3 can block the thermal energy of the second heating structure (H2), so that outward heat transmission can be reduced, and the effect of low energy consumption can be achieved. Simultaneously, the second inner mold 33 is removably connected to the second outer mold 31 by operating the screw bolts 36, so that the second inner mold 33 can be replaced with a different shoe component shape that matches with that of the first inner mold 23. Thus, the flexibility of this disclosure can be increased, and the manufacturing cost thereof can be reduced.

The second cover plate 35 matches the shape of the second inner mold 33 to cover and seal the second gap (S2), so that the outward heat transmission can be effectively blocked.

In this embodiment, the first thermal insulation plate 22, the second thermal insulation plate 32, the first cover plate 25 and the second cover plate 35 may be selectively omitted according to actual requirement, as long as the first gap (S1) and the second gap (S2) can be used to block outward heat transmission and achieve saving of energy consumption.

The first heating plate 231, the first inner mold body 232, the second heating plate 331 and the second inner mold body 332 can be made according to the requirement by one of CNC machining method, a casting method, or a metal three-dimensional (3D) printing method.

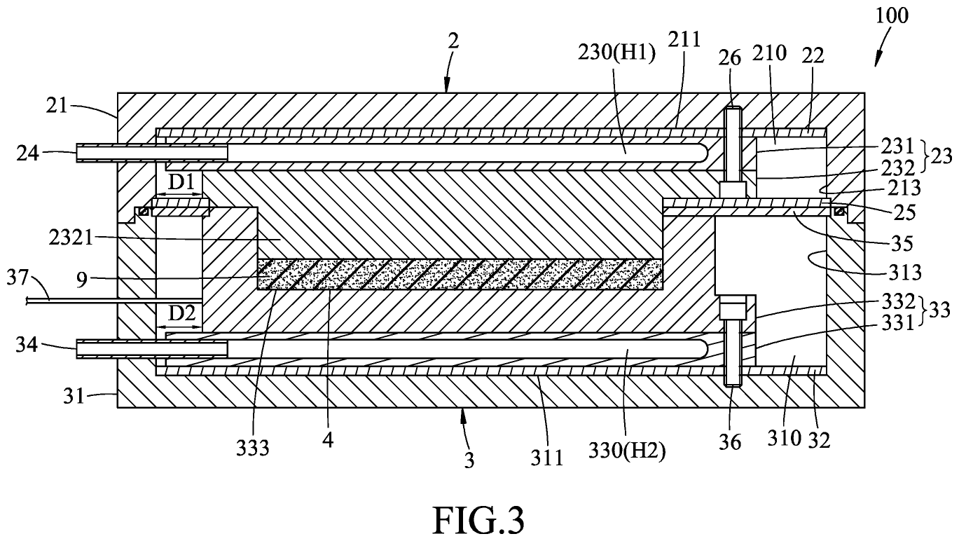

The temperature sensor 37 (see FIG. 3) is inserted from the outside into the second receiving space 310 in close proximity to the mold cavity 4, so that the temperature of the mold cavity 4 can be accurately measured by the temperature sensor 37, thereby achieving an optimal hot compacting condition and improving the quality of the hot compacting.

A method for forming the shoe component 9 using the molding apparatus 100 of the first embodiment by hot compacting will be briefly described below.

With reference to FIGS. 1 to 5, the shoe component blank (not shown) is placed in the mold cavity 4 between the first and second inner molds 23, 33. Next, a vacuum equipment (not shown) is used to pump air out of the first gap (S1) and the second gap (S2) through the first and second air holes 212, 312 to place the first gap (S1) and the second gap (S2) in vacuum states. Then, hot steam or hot water is sent by the supply device to the first flow channels 230 through the respective first through pipes 24 to heat the first inner mold 23, and hot steam or hot water is also sent by the supply device to the second flow channels 330 through the respective second through pipes 34 to heat the second inner mold 33. During the heating process, since the first and second inner molds 23, 33 can be directly heated, a heating efficiency of this disclosure is high. Further, with the first gap (S1) and the second gap (S2) maintained in vacuum states, outward heat transmission can be blocked and low energy consumption can be achieved. After the shoe component blank is heated, it will foam and expand to fill the mold cavity 4, thereby forming the shoe component 9.

It is worth to mention herein that, vacuuming is not an essential condition in this disclosure, as long as the outward heat transmission can be blocked and the low energy consumption can be achieved through the first gap (S1) and the second gap (S2).

Finally, after the shoe component 9 is formed, cold water is guided into the first flow channels 230 and the second flow channels 330 as the cooling source. After the temperatures of the first inner mold 23 and the second inner mold 33 have cooled down, the shoe component 9 can be removed from the mold cavity 4. However, it is not an essential condition to guide cold water in this disclosure, the present disclosure can also adopt natural cooling.

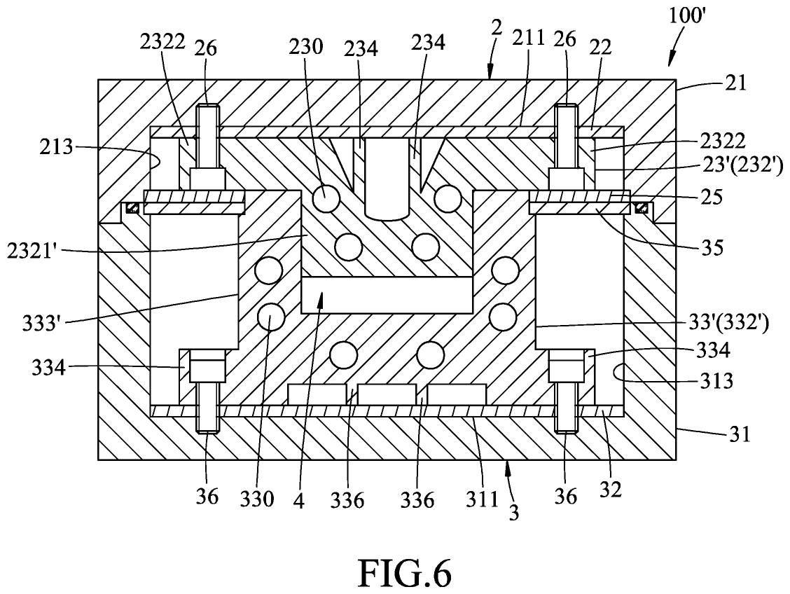

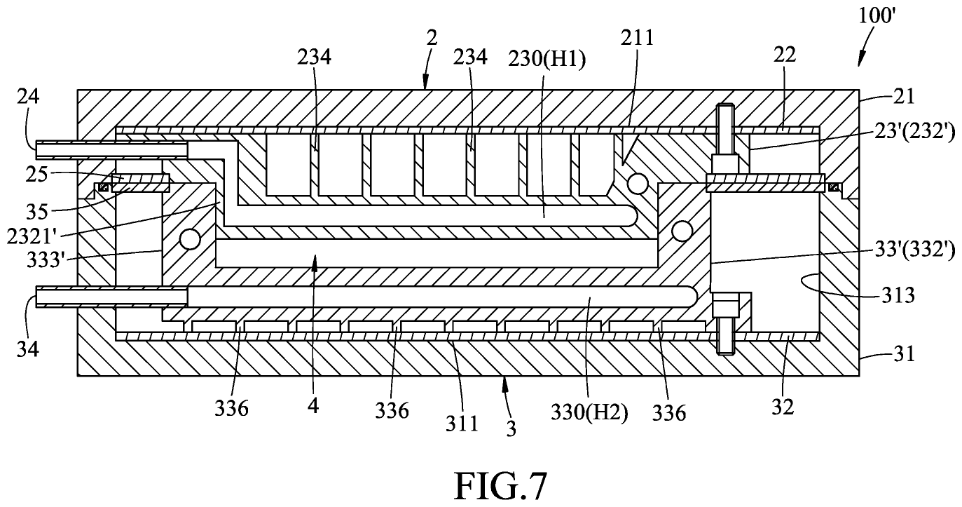

Referring to FIGS. 6 and 7, the second embodiment of the molding apparatus 100′ according to this disclosure is shown to be similar to the first embodiment. However, in the second embodiment, the first heating plate 231 (see FIG. 3) of the first inner mold 23′ is omitted herein, so that the first thermal insulation plate 22 is disposed between the inner base surface 211 of the first outer mold 21 and the first inner mold 23′. Further, the first inner mold 23′ is formed by three-dimensional printing, in which metals, such as aluminum alloy or steel, are stacked. The first inner mold 23′ has a first inner mold body 232′, and a plurality of first posts 234 extending from the first inner mold body 232′ toward the first thermal insulation plate 22. The first flow channel 230 is simultaneously formed in the protruding portion 2321′ of the first inner mold body 232′ during the three-dimensional printing of the first inner mold 23′. With the first posts 234 supporting the first inner mold body 232′, the overall structural strength of the first inner mold 23′ can be enhanced.

The second heating plate 331 (see FIG. 3) of the second inner mold 33′ is also omitted herein, so that the second thermal insulation plate 32 is disposed between the inner base surface 311 of the second outer mold 31 and the second inner mold 33′. Further, the second inner mold 33′ is also formed by three-dimensional printing, in which metals, such as aluminum alloy or steel, are stacked. The second inner mold 33′ has a second inner mold body 332′, and a plurality of second posts 334 extending from the second inner mold body 332′ toward the second thermal insulation plate 32. The second flow channel 330 is simultaneously formed in the concave portion 333′ of the second inner mold body 332′ during the three-dimensional printing of the second inner mold 33′. With the second posts 334 supporting the second inner mold body 332′, the overall structural strength of the second inner mold 33′ can be enhanced.

Apart from achieving the same effect of high heating efficiency and low energy consumption as described in the first embodiment, the second embodiment further uses three-dimensional printing for respectively forming the first flow channel 230 and the second flow channel 330 in the first inner mold 23′ and the second inner mold 33′, respectively, so that the first flow channel 230 and the second flow channel 330 can be closer to the mold cavity 4 for a better thermal conductivity effect. The second embodiment is also applicable to a hot compacting process that requires repeated alternating hot and cold operations.

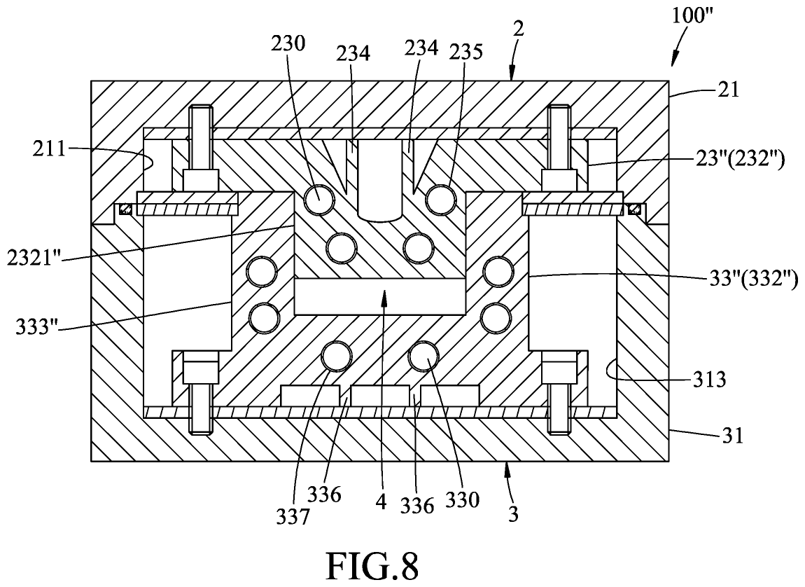

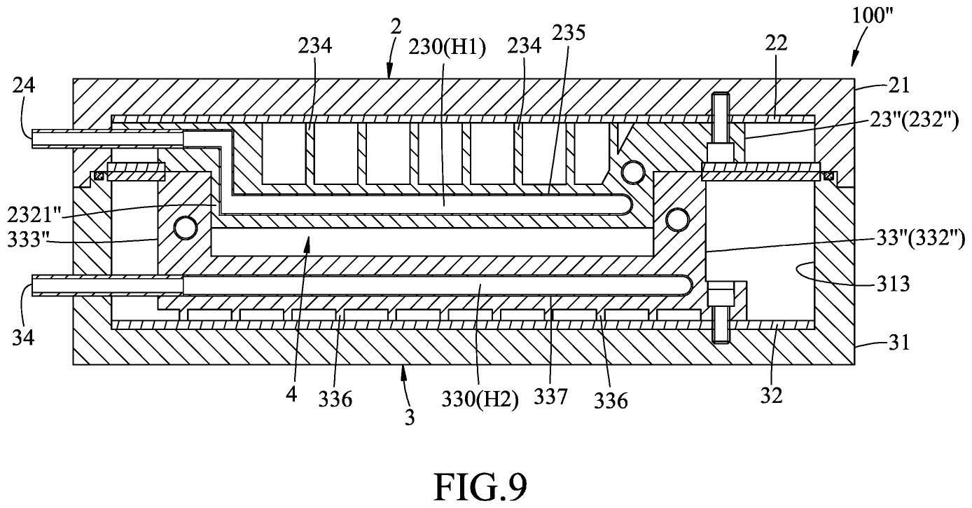

Referring to FIGS. 8 and 9, the third embodiment of the molding apparatus 100″ according to this disclosure is shown to be similar to the second embodiment. However, in the third embodiment, the first inner mold 23″ is three-dimensionally printed to forma first inner mold body 232″ having a breathable porous structure, and a first tubular wall 235 formed in the protruding portion 2321″ of the first inner mold body 232″ and defining the first flow channel 230. By controlling the stacking density of the three-dimensional printing of the metals, the first inner mold body 232″ having the breathable porous structure can be obtained.

The second inner mold 33″ is three-dimensionally printed to form the second inner mold body 332″ having a breathable porous structure, and a second tubular wall 337 formed in the concave portion 333″ of the second inner mold body 332″ and defining the second flow channel 330.

Apart from achieving the same effect of high heating efficiency, low energy consumption and good thermal conductivity as described in the second embodiment, during vacuum hot compacting, the first inner mold body 232″ and the second inner mold body 332″ of the third embodiment, each of which has the breathable porous structure, can provide passage of air to generate negative pressure on the mold cavity 4, so that the shoe component 9 (see FIG. 3) can abut more tightly against the mold cavity 4 during forming, and can completely conform to the pattern appearance of the mold cavity 4. Thus, the third embodiment has a better molding clarity.

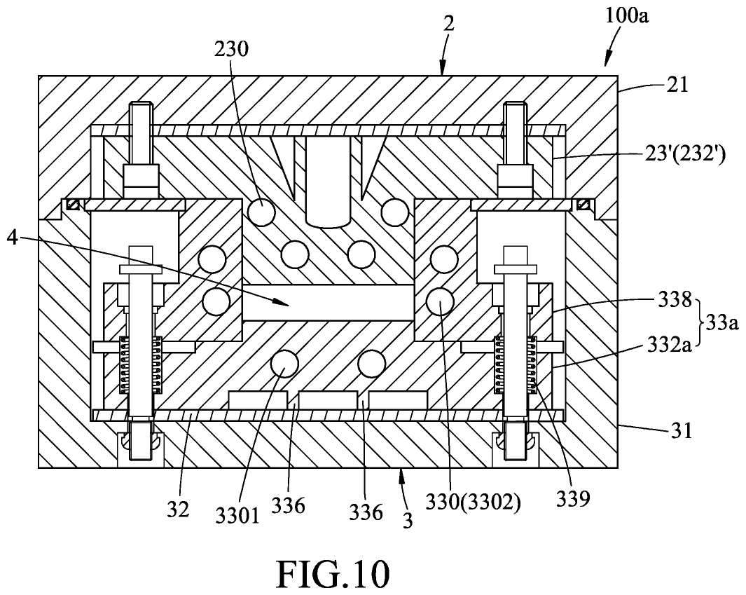

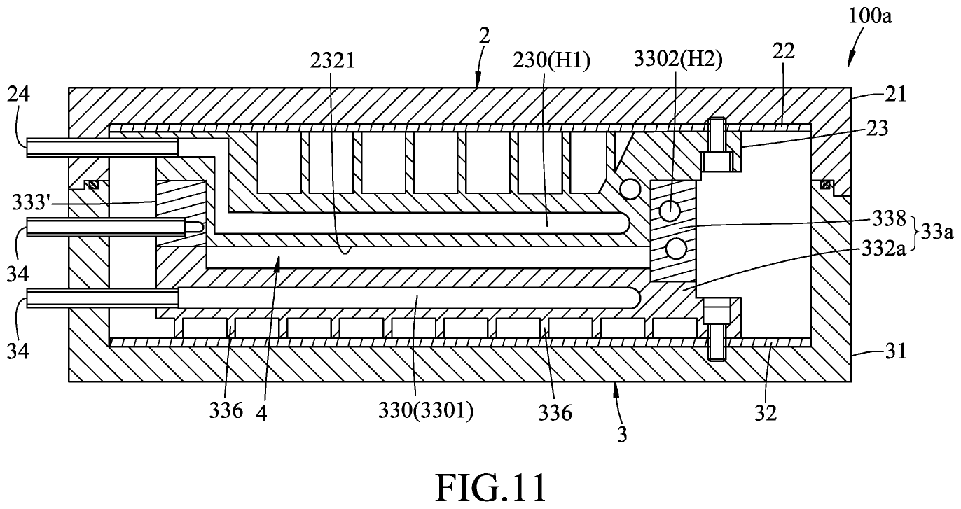

Referring to FIGS. 10 and 11, the fourth embodiment of the molding apparatus (100a) according to this disclosure is shown to be similar to the second embodiment. However, in the fourth embodiment, the second inner mold (33a) includes a second inner mold body (332a) disposed on the second thermal insulation plate 32, and a third inner mold body 338 connected to the second inner mold body (332a) using a plurality of compression springs 339 disposed on the second inner mold body (332a). When the mold is open, the third inner mold body 338 can be automatically and resiliently pushed away from the second inner mold body (332a). The mold cavity 4 is cooperatively defined by the first to third inner mold bodies 232′, 332a, 338. The second flow channel 330 has a main flow channel 3301 formed in the second inner mold body (332a), and a side flow channel 3302 formed in the third inner mold body 338. The main flow channel 3301 and the side flow channel 3302 communicate with the external environment for connection with two second through pipes 34, respectively.

It is worth to mention herein that the first inner mold 23 and the second inner mold 33 of each of the aforesaid embodiments can be used interchangeably. The effect of blocking outward heat transmission and the low energy consumption can be similarly achieved. Further, the present disclosure is not limited to a double-removal type mold. For forming a multi-colored shoe component 9, a sharp corner shoe component 9 or a complicated contour shoe component 9, more than two removable type mold may be used.

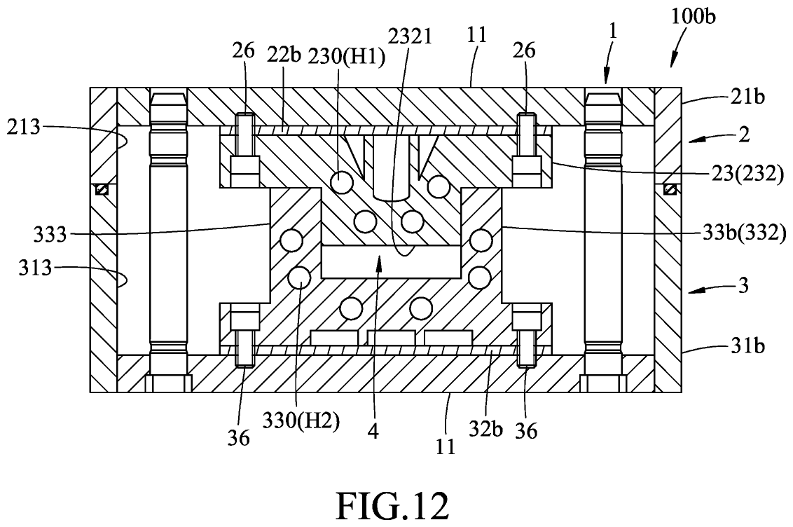

Referring to FIG. 12, the fifth embodiment of the molding apparatus (100b) according to this disclosure is shown to be similar to the second embodiment. However, in the fifth embodiment, the first outer mold (21b) of the first mold 2 is mounted on one of the mounting plates 11 of the forming equipment 1, and completely surrounds the first inner mold 23; and the second outer mold (31b) of the second mold 3 is mounted on the other mounting plate 11 of the forming equipment 1, and completely surrounds the second inner mold 33. The first thermal insulation plate (22b) and the first inner mold (23b) are threadedly connected to the one of the mounting plates 11, while the second thermal insulation plate (32b) and the second inner mold (33b) are threadedly connected to the other mounting plate 11.

When the mounting plates 11 of the forming equipment 1 are moved close to each other and the first mold 2 abuts against the second mold 3, the first outer mold (21b) and the second outer mold (31b) tightly contact each other and form a vacuum cover. The first gap (S1) (see FIG. 4) and the second gap (S2) (see FIG. 5) can be similarly formed. Thus, this embodiment can serve the same function of high heat efficiency and low energy consumption as described in the second embodiment.

In sum, the first heating structure (H1) and the second heating structure (H2) of this disclosure can directly and respectively heat the first inner mold 23, 23′, 23″, 23b and the second inner mold 33, 33′, 33″, 33b. Further, by using the first gap (S1) and the second gap (S2), outward heat transmission can be blocked and low energy consumption can be achieved. Moreover, the first inner molds 23, 23′, 23″, 23b and the second inner molds 33, 33′, 33″, 33b can be removed and changed to different shoe component shapes. Therefore, the object of this disclosure can indeed be achieved.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A molding apparatus for forming a shoe component, comprising:
a first mold including a first outer mold and a first inner mold, said first outer mold having an inner base surface and an inner peripheral surface that cooperatively define a first receiving space, said first inner mold being disposed in said first receiving space and having a first heating structure, said first inner mold and said inner peripheral surface of said first outer mold having a first gap formed therebetween; and
a second mold including a second outer mold and a second inner mold, said second outer mold having an inner base surface and an inner peripheral surface that cooperatively define a second receiving space, said second inner mold being disposed in said second receiving space and having a second heating structure, said second inner mold and said inner peripheral surface of said second outer mold having a second gap formed therebetween;
wherein said first mold and said second mold are movable toward and away from each other; and
wherein said first inner mold and said second inner mold cooperatively define a mold cavity.

2. The molding apparatus for forming a shoe component as claimed in claim 1, wherein said first inner mold is removably connected to said first outer mold, and has a first inner mold body, a protruding portion protruding out of said first receiving space from said first inner mold body, and at least three first connecting portions formed on a peripheral edge of said first inner mold body for connection with said first outer mold, said peripheral edge of said first inner mold body and said inner peripheral surface of said first outer mold having a shortest distance therebetween larger than or equal to 5 mm.

3. The molding apparatus for forming a shoe component as claimed in claim 2, wherein the shortest distance between said peripheral edge of said first inner mold body and said inner peripheral surface of said first outer mold is larger than or equal to 10 mm.

4. The molding apparatus for forming a shoe component as claimed in claim 2, wherein said second inner mold is removably connected to said second outer mold, and has a second inner mold body, a concave portion extending inwardly from said second inner mold body for receiving and cooperating with said protruding portion to confine said mold cavity therebetween, and at least three second connecting portions formed on a peripheral edge of said second inner mold body for connection with said second outer mold, said peripheral edge of said second inner mold body and said inner peripheral surface of said second outer mold having a shortest distance therebetween larger than or equal to 5 mm.

5. The molding apparatus for forming a shoe component as claimed in claim 4, wherein the shortest distance between said peripheral edge of said second inner mold body and said inner peripheral surface of said second outer mold is larger than or equal to 10 mm.

6. The molding apparatus for forming a shoe component as claimed in claim 2, wherein said first inner mold further has a first heating plate disposed between said first outer mold and said first inner mold body, said first heating plate having at least one first flow channel formed therein for receiving fluid to form said first heating structure.

7. The molding apparatus for forming a shoe component as claimed in claim 6, wherein said first mold further includes a first thermal insulation plate disposed between said first outer mold and said first heating plate.

8. The molding apparatus for forming a shoe component as claimed in claim 1, wherein said first mold further includes a first thermal insulation plate disposed between said first outer mold and said first inner mold.

9. The molding apparatus for forming a shoe component as claimed in claim 1, wherein said second inner mold has at least one second flow channel formed therein for receiving fluid to form said second heating structure.

10. The molding apparatus for forming a shoe component as claimed in claim 9, wherein said second inner mold is formed by three-dimensional (3D) printing, said second inner mold including a second inner mold body, and a third inner mold body removably connected to said second inner mold body, said second inner mold body being disposed on said second outer mold, said at least one second flow channel having a main flow channel formed in said second inner mold body, and a side flow channel formed in said third inner mold body.

11. The molding apparatus for forming a shoe component as claimed in claim 1, wherein said first inner mold has at least one first flow channel formed therein for receiving fluid to form said first heating structure.

12. The molding apparatus for forming a shoe component as claimed in claim 11, wherein said first inner mold is formed by three-dimensional (3D) printing, and has a first inner mold body and a plurality of first posts extending from said first inner mold body toward said inner base surface of said first outer mold, said at least one flow channel being formed in said first inner mold body.

13. The molding apparatus for forming a shoe component as claimed in claim 11, wherein said first inner mold is formed by three-dimensional (3D) printing, and has a first inner mold body with a breathable porous structure, and a first tubular wall formed in said first inner mold body and defining said at least one first flow channel.

14. The molding apparatus for forming a shoe component as claimed in claim 1, wherein said second outer mold further has a temperature sensor inserted into said second receiving space in close proximity to said mold cavity.

15. The molding apparatus for forming a shoe component as claimed in claim 13, wherein said first gap and said second gap are in a vacuum state during hot compacting of said shoe component.
